(19) United States
(12) Patent Application Publication
(10) Pub. No.: US 2013/0314403 A1
(43) Pub. Date: Nov. 28, 2013

(54) METHOD FOR SPLICING POINT CLOUDS TOGETHER

(71) Applicants: HONG FU JIN PRECISION INDUSTRY (SHENZHEN) CO., LTD., Shenzhen (CN); HON HAI PRECISION INDUSTRY CO., LTD., New Taipei (CN)

(72) Inventors: CHIH-KUANG CHANG, New Taipei (TW); XIN-YUAN WU, Shenzhen (CN); JIN-GANG RAO, Shenzhen (CN)

(73) Assignees: HON HAI PRECISION INDUSTRY CO., LTD., New Taipei (CN); HONG FU JIN PRECISION INDUSTRY (ShenZhen) CO., LTD., Shenzhen (CN)

(21) Appl. No.: 13/887,411

(22) Filed: May 6, 2013

(30) Foreign Application Priority Data
May 22, 2012 (CN) 2012101594722

(51) Int. Cl. G06T 15/00

(52) U.S. Cl. CPC G06T 15/005
USPC 345/419

(57) ABSTRACT

A computing device receives more than one point cloud. There are mark point clouds on each point cloud. The computing device fits each mark point cloud to an ellipse. A point cloud is selected and a group of the selected point cloud is taken as a first group. Each group of other point clouds is taken as a second group. The computing device aligns a second group to the first group and obtains a rotation matrix corresponding to the second group. The point cloud corresponding to the second group is aligned to the point cloud corresponding to the first group according to the rotation matrix.

### BACKGROUND

1. Technical Field

Embodiments of the present disclosure relate to point clouds management systems and methods, and particularly to a method for splicing point clouds together.

2. Description of Related Art

A point cloud is a set of points in a three-dimensional (3D) coordinate system and may be defined by an X, Y, Z coordinate system. Point clouds are often created by a scanning system that measures a large number of points on a surface of an object and outputs the point cloud as a data file. Due to different shapes of objects, the scanning system needs different jigs, which increase measurement costs. Furthermore, the scanned point clouds cannot be spliced together accurately.

### BRIEF DESCRIPTION OF THE DRAWINGS

FIG. 1 is a block diagram of one embodiment of a computing device including a splicing system.

FIG. 2 is a flowchart illustrating one embodiment of a method for splicing together point clouds.

FIG. 3 is a flowchart of one embodiment of a detailed description of step S21 in FIG. 2.

FIG. 4 is a flowchart of one embodiment of a detailed description of step S210 in FIG. 3.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware unit, or to a collection of software instructions, written in a programming language. One or more software instructions in the modules may be embedded in firmware unit, such as in an EPROM. The modules described herein may be implemented as either software and/or hardware modules and may be stored in any type of non-transitory computer-readable medium or other storage device. Some non-limiting examples of non-transitory computer-readable media may include CDs, DVDs, BLU-RAY, flash memory, and hard disk drives.

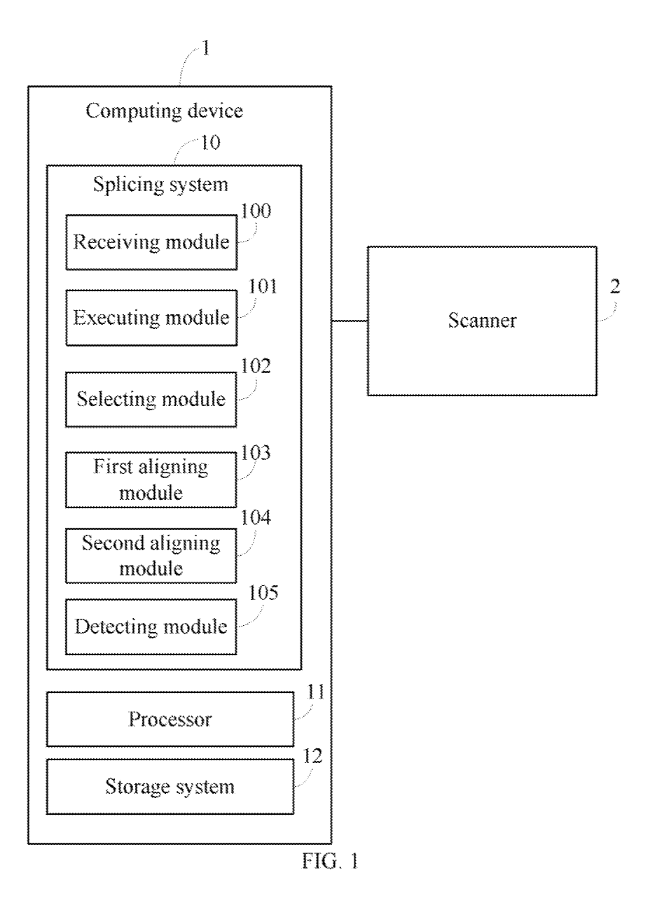

FIG. 1 is a block diagram of one embodiment of a computing device 1. The computing device 1 is electronically connected with a scanner 2. The scanner 2 scans a surface of one or more objects. The computing device 1 receives the point clouds from the scanner 2 and obtains a grayscale of each pixel point of the point clouds. The computing device 1 includes a splicing system 10, at least one processor 11, and a storage system 12. The splicing system 10 splices together a plurality of point clouds of an object to obtain a single unitary point cloud of the object.

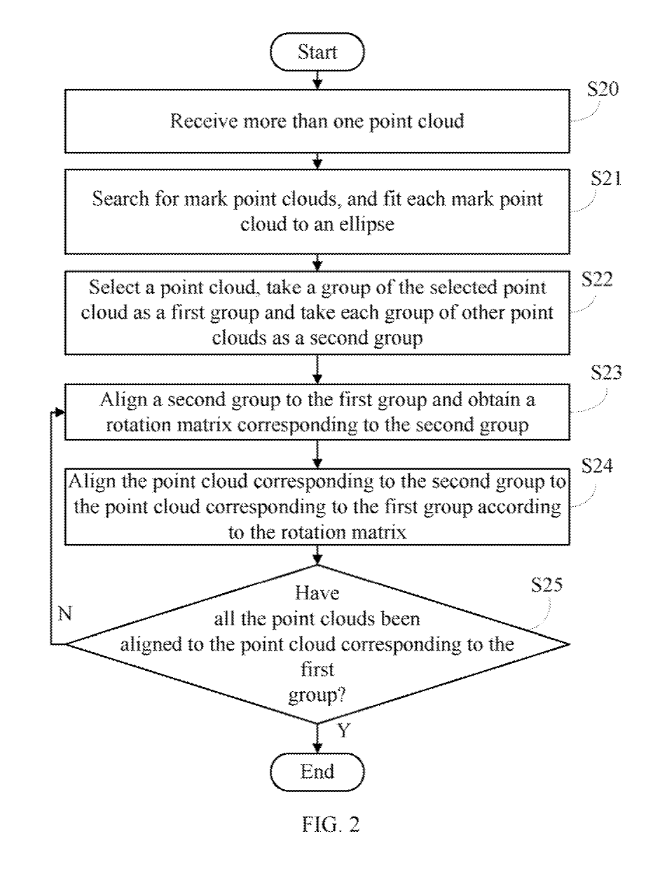

The splicing system 10 includes an receiving module 100, an executing module 101, a selecting module 102, a first aligning module 103, a second aligning module 104, and a detecting module 105. The one or more modules may comprise computerized instructions in the form of one or more programs that are stored in the storage system 12 and executed by the at least one processor 11 to provide functions of the computing device 1. The function modules 100-105 provide at least the functions needed to execute the steps illustrated in FIG. 2.

FIG. 2 is a flowchart illustrating embodiments of a method for splicing together point clouds. Depending on the embodiment, additional steps may be added, others removed, and the ordering of the steps may be changed.

In step S20, the receiving module 100 receives more than one point cloud from the scanner 2.

In step S21, the executing module 101 searches for mark point clouds, and respectively fits each mark point cloud to an ellipse. In one embodiment, each mark point cloud has a closed outline. The executing module 101 further cuts the fitted ellipses and obtains remainder ellipses, takes each point cloud which includes the remainder ellipses as a group, and stores each group in an array. The remainder ellipses are the fitted ellipses except for the cut ellipses. For example, the executing module 101 takes a first point cloud including the remainder ellipses as a first group and stores the first group as an array P0. A second point cloud including the remainder ellipses is taken as a second group and the second group is stored as an array P1. An (n−1) point cloud including the remainder ellipses is taken as a (n−1) group and the (n−1) group is stored as an array Pn.

In step S22, the selecting module 102 selects a point cloud which includes the remainder ellipses, takes the group of the selected point cloud as a first group and takes each group of other point clouds which includes the remaining remainder ellipses as a second group.

In step S23, the first aligning module 103 aligns a second group to the first group and obtains a rotation matrix relative to the second group.

In step S24, the second aligning module 104 aligns the point cloud corresponding to the second group to the point cloud corresponding to the first group according to the rotation matrix and a degree of precision set by a user.

In step S25, the detecting module 105 detects whether all the point clouds which include the remainder ellipses have been aligned to the point cloud corresponding to the first group. When there are any point clouds that have not been aligned to the point cloud corresponding to the first group, steps S23-S25 are repeated. When all point clouds have been aligned to the point cloud corresponding to the first group, the procedure ends.

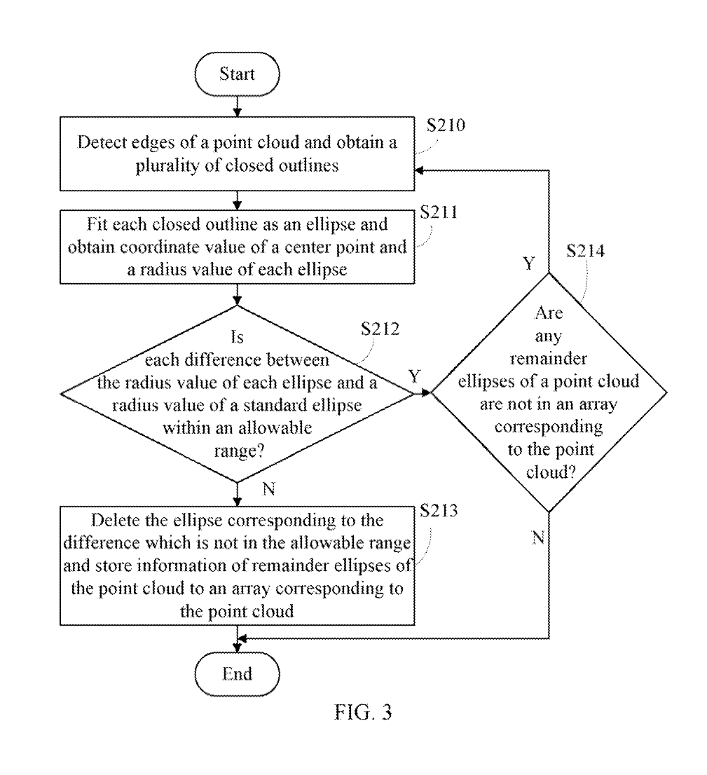

FIG. 3 is a flowchart of one embodiment of a detailed description of step S21 in FIG. 2. Depending on the embodiment, additional steps may be added, others removed, and the ordering of the steps may be changed.

In step S210, the executing module 101 detects edges of a point cloud and obtains a plurality of closed outlines.

In step S211, each closed outline is fitted as an ellipse by using a mathematical method. In one embodiment, the mathematical method may be a least square method. The executing module 101 obtains coordinate values of a center point and a radius value of each ellipse.

In step S212, the executing module 101 calculates a difference between the radius value of each ellipse and a radius value of a standard ellipse, and detects whether each difference is in an allowable range. When a difference is not in the allowable range, step S213 is implemented. When all the differences are in the allowable range, step S214 is implemented.

In step S213, the executing module 101 deletes any ellipse with a difference which is not in the allowable range, and stores information of the remainder ellipses of the point cloud to an array corresponding to the point cloud.

In step S214, the executing module 101 detects whether any remainder ellipses of a point cloud are not in an array corresponding to the point cloud. When any remainder ellipses of a point cloud are not in the array corresponding to the point cloud, step S210 to step S212 is repeated. When all the remainder ellipses of each point cloud are in an array corresponding to each point cloud, procedure ends.

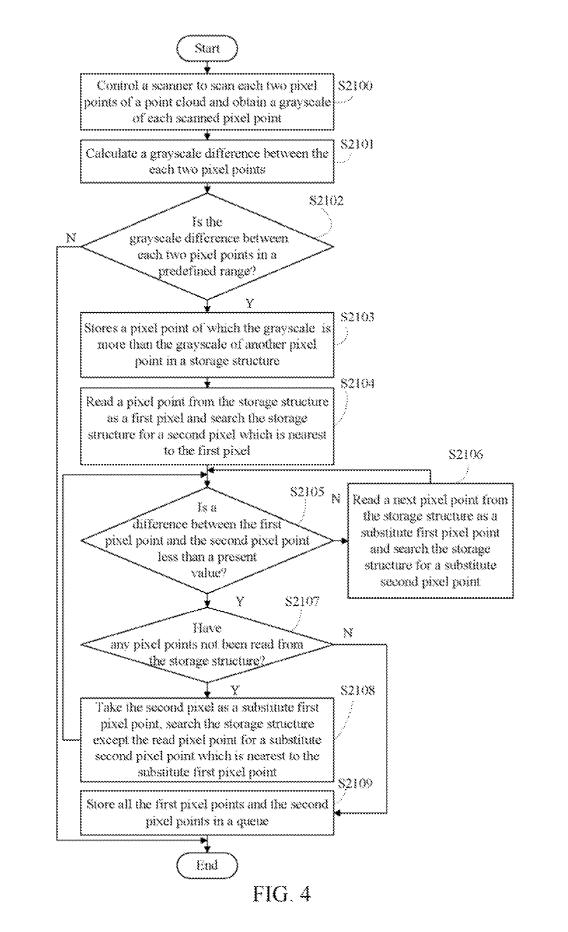

FIG. 4 is a flowchart of one embodiment of a detailed description of step S210 in FIG. 3. Depending on the embodiment, additional steps may be added, others removed, and the ordering of the steps may be changed.

In step S2100, the executing module 101 controls the scanner 2 to scan each two pixel points of a point cloud at preset intervals in a predefined direction, and obtain a grayscale of each pixel point scanned by the scanner 2. The preset interval is a distance between one pixel point and another pixel point.

In step S2101, the executing module 101 calculates a grayscale difference between each two pixel points.

In step S2102, the executing module 101 detects whether the grayscale difference between each two pixel points is within a predefined range. In one embodiment, the predefined range is more than 125. When the grayscale difference between two pixel points is within the predefined range, step S2103 is implemented. When all the grayscale differences between every two pixel points are not inside the predefined range, the procedure ends.

In step S2103, the executing module 101 determines a pixel point from each two pixel points, the grayscale of which is more than the grayscale of another pixel point in each two pixel points. The determined pixel point of each two pixel points is stored in a storage structure. In one embodiment, the storage structure is an array or a queue.

In step S2104, the executing module 101 reads a pixel point from the storage structure as a first pixel point. The executing module 101 further searches the storage structure for a second pixel point which is nearest to the first pixel point based on a bounding box technology.

In step S2105, the executing module 101 detects whether a difference between the first pixel point and the second pixel point is less than a preset value. When the difference between the first pixel point and the second pixel point is less than the preset value, step S2107 is implemented. When the difference between the first pixel point and the second pixel point is not less than the preset value, in step S2106, the executing module 101 reads the next pixel point from the storage structure as a substitute first pixel point, and searches the storage structure for a new second pixel point, and step S2105 is repeated.

In step S2107, the executing module 101 detects whether any pixel points have not been read from the storage structure. When there are pixel points which have not been read from the storage structure, step S2108 is implemented. When all the pixel points have been read from the storage structure, step S2109 is implemented.

In step S2108, the second pixel point is taken as a new first pixel point. The executing module 101 searches the storage structure except for the read pixel point for a substitute second pixel point which is the nearest to the new first pixel point.

In step S2109, the executing module 101 stores all the first pixel points and the second pixel points in a queue. All the first pixel points and the second pixel points in the queue form a closed outline.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a computing device for splicing point cloud, comprising:
receiving more than one point cloud transmitted by a scanner connected to the computing device;
searching each point cloud for mark point clouds, and fitting each mark point cloud to an ellipse;
selecting a point cloud, taking a group of the selected point cloud as a first group and taking each group of other point clouds as a second group;
aligning a second group to the first group and obtaining a rotation matrix corresponding to the second group; and
aligning the point cloud corresponding to the second group to the point cloud corresponding to the first group according to the rotation matrix and a degree of precision.

2. The method as described in claim 1, after fitting the mark points on each point cloud to an ellipse further comprising:
cutting the fit ellipses to obtain remainder ellipses, taking each point cloud which includes the remainder ellipses as a group, and storing each group to a corresponding array.

3. The method as described in claim 1, further comprising:
(a) detecting edges of a point cloud and obtaining a plurality of closed outlines;
(b) fitting each closed outline as an ellipse by using a mathematical method, and obtaining coordinate value of a center point and a radius value of each ellipse;
(c) calculating a difference between the radius value of each ellipse and a radius value of a standard ellipse, and detecting whether each difference is in an allowable range;
(d) deleting the ellipse corresponding to the difference which is not in the allowable range and storing information of the remainder ellipses of the point cloud to an array corresponding to the point cloud; and
(e) repeating step (a) to step (c) till the remainder ellipses of each point cloud are in an array corresponding to each point cloud.

4. The method device as described in claim 3, wherein the mathematical method is a least square method.

5. The method as described in claim 3, wherein step (a) further comprises:
(a1) controlling the scanner to scan each two pixel points of a point cloud at a preset interval in a predefined direction, and obtaining a grayscale of each pixel point scanned by the scanner;
(a2) calculating a grayscale difference between each two pixel points;
determining a pixel point from each two pixel points, the grayscale of which is more than the grayscale of another pixel point in each two pixel points when the grayscale difference between two pixel points is in the predefined range, and storing the determined pixel point of each two pixel points in a storage structure;
(a3) reading a pixel point from the storage structure as a first pixel point, and searching the storage structure for a second pixel point which is nearest to the first pixel point based on a bounding box technology;
(a4) detecting whether a difference between the first pixel point and the second pixel point is less than a preset value;
(a5) reading a next pixel point from the storage structure as a substitute first pixel point, searching the storage structure for a substitute second pixel point, and repeating step (a5) when the difference between the first pixel point and the second pixel point is not less than the preset value;
(a6) detecting whether any pixel points have not been read from the storage structure;
(a7) taking the second pixel point as a substitute first pixel point, and searching the storage structure except for the read pixel point for a substitute second pixel point which is the nearest to the substitute first pixel point when any pixel points have not been read from the storage structure; and
(a8) storing all the first pixel points and the second pixel points in a queue when all the pixel points have been read from the storage structure.

6. A non-transitory storage medium having stored thereon instructions that, when executed by a processor, causes the processor to perform a method for splicing point cloud, the method comprising:
receiving more than one point cloud transmitted by a scanner connected to the computing device;
searching each point cloud for mark point clouds, and fitting each mark point cloud to an ellipse;
selecting a point cloud, taking a group of the selected point cloud as a first group and taking each group of other point clouds as a second group;
aligning a second group to the first group and obtaining a rotation matrix corresponding to the second group; and
aligning the point cloud corresponding to the second group to the point cloud corresponding to the first group according to the rotation matrix and a degree of precision.

7. The non-transitory storage medium as described in claim 6, after fitting the mark points on each point cloud to an ellipse further comprising:
cutting the fit ellipses to obtain remainder ellipses, taking each point cloud which includes the remainder ellipses as a group, and storing each group to a corresponding array.

8. The non-transitory storage medium as described in claim 6, further comprising:
(a) detecting edges of a point cloud and obtaining a plurality of closed outlines;
(b) fitting each closed outline as an ellipse by using a mathematical method, and obtaining coordinate value of a center point and a radius value of each ellipse;
(c) calculating a difference between the radius value of each ellipse and a radius value of a standard ellipse, and detecting whether each difference is in an allowable range;
(d) deleting the ellipse corresponding to the difference which is not in the allowable range and storing information of the remainder ellipses of the point cloud to an array corresponding to the point cloud; and
(e) repeating step (a) to step (c) till the remainder ellipses of each point cloud are in an array corresponding to each point cloud.

9. The non-transitory storage medium as described in claim 8, wherein the mathematical method is a least square method.

10. The non-transitory storage medium as described in claim 8, wherein step (a) further comprises:
(a1) controlling the scanner to scan each two pixel points of a point cloud at a preset interval in a predefined direction, and obtaining a grayscale of each pixel point scanned by the scanner;
(a2) calculating a grayscale difference between each two pixel points;
determining a pixel point from each two pixel points, the grayscale of which is more than the grayscale of another pixel point in each two pixel points when the grayscale difference between two pixel points is in the predefined range, and storing the determined pixel point of each two pixel points in a storage structure;
(a3) reading a pixel point from the storage structure as a first pixel point, and searching the storage structure for a second pixel point which is nearest to the first pixel point based on a bounding box technology;
(a4) detecting whether a difference between the first pixel point and the second pixel point is less than a preset value;
(a5) reading a next pixel point from the storage structure as a substitute first pixel point, searching the storage structure for a substitute second pixel point, and repeating step (a5) when the difference between the first pixel point and the second pixel point is not less than the preset value;
(a6) detecting whether any pixel points have not been read from the storage structure;
(a7) taking the second pixel point as a substitute first pixel point, and searching the storage structure except for the read pixel point for a substitute second pixel point which is the nearest to the substitute first pixel point when any pixel points have not been read from the storage structure; and
(a8) storing all the first pixel points and the second pixel points in a queue when all the pixel points have been read from the storage structure.
